(19) United States
(12) Patent Application Publication
(10) Pub. No.: US 2006/0055547 A1
(43) Pub. Date: Mar. 16, 2006

(54) Warning device for clogged air filter

(76) Inventor: Edward G. DiMaggio, Hammond, LA (US)

Correspondence Address: KEATY PROFESSIONAL LAW CORPORATION;THOMAS S. KEATY, 2533 AMERICAN WAY, PORT ALLEN, LA, 70767, US

(21) Appl. No.: 10/942,694

(22) Filed: Sep. 16, 2004

(51) Int. Cl. G08B 21/00

(52) U.S. Cl. 340/607

(57) ABSTRACT

A warning for identifying clogged air filter condition uses a sensor mounted in the air passage downstream of the air filter. The sensor is connected to an electrical power generator, which transmits the electrical power to a selected one of the light emitting or audio signal emitting members in response to the decrease in the air flow passing across the air filter.

### BACKGROUND OF THE INVENTION

This invention relates to air filtration systems, and, more particularly, to an air filtration system that contains an alarm for notifying the user that the air filter in the system has become clogged and dirty.

Heat and ventilation systems, commonly known as HVAC systems, are equipped with air permeable filters that are placed in a special opening connected to a return air duct. Conventional air filters comprise a grid of plastic or metal, within which a porous, air-permeable membrane is secured. With time, the filter becomes clogged with dust or dirt, which causes reduction in the airflow on the downstream side of the filter. Sometimes the heat and air system is malfunctioning due to ice formation on the intake which can be caused by the differences in the humidity level between the inside of the house and outside of the building. The dirt, icing, and other such airflow reducing factors cause the fan unit to overload and overheat, which can ultimately lead to the destruction of the motor. The replacement of the motor can be very expensive and as a result, the building owners are encouraged to regularly replace or clean the air filters and to check the intake of the air conditioning system for ice and dirt accumulation.

However, visual inspection is tedious and time consuming, especially if the technician has to check multiple filters in an apartment building or an office building. The disadvantage of the visual inspection is that the technician or the homeowner may not properly detect the degree of clogging in the filter, thereby making it difficult to determine whether the airflow that passes through the filter is of the right amount or is greatly reduced due to clogging.

The present invention contemplates elimination of drawbacks associated with detection of a clogged filter and provision of a simple and inexpensive device that can be incorporated into the existing air filtration systems or supplied as a kit as part of the HVAC system.

### SUMMARY OF THE INVENTION

It is therefore an object of the present invention to provide a warning device for a homeowner or a service technician that the air filter needs replacement or cleaning.

It is a further object of the present invention to provide a visual means for indicating the degree of clogging of the air filter.

Still another object of the present invention is to provide an audible warning device for signaling when the airflow across the filter falls below a pre-determined threshold value.

These and other objects of the present invention are achieved through a provision of a warning system for use with furnace or air conditioning systems. The warning device comprises a sensor mounted on the downstream side of the filter, which reacts to the reduction in the air flow across the filter. The sensor is operationally connected to a generator of electrical power, or motor means for generating electrical current when the sensor is forced to move by the air current.

The electrical power generator is operationally connected to one or more light emitting members mounted on the upstream side of the air filter in a location, where the light emitting member(s) can be seen by a user. In a system, which employs a plurality of light emitting members, a relay is mounted between the motor and the light emitting members for directing a pre-determined electrical potential to different light emitting members. The light emitting members may be provided with different color lenses, which are illuminated depending on the degree of air flow acting on the sensor. For instance, when the airflow has a pre-determined value indicative of a clean air filter, the green light emitting member may be illuminated. When the air flow is reduced to a non-acceptable level and the sensor stops moving, a red light emitting member may be illuminated.

The system further contemplates he use of an audible signal corresponding to the unacceptable air flow across the filter, as well as a means for setting the value of air flow considered acceptable during heating or cooling seasons.

### BRIEF DESCRIPTION OF THE DRAWINGS

Reference will now be made to the drawings, wherein like parts are designated by like numerals and wherein FIG. 1 is a schematic view of the warning system for dirty air filters in accordance with the present invention.

FIG. 2 is a schematic view of an alternative system of the present invention.

### DETAILED DESCRIPTION OF THE PREFERRED EMBODIMENT

Turning now to the drawing in more detail, numeral 10 designates a return air filter mounted in an opening leading to an air passage 12. The filter 10 has an upstream side 11 and a downstream side 13. The return airflow, schematically illustrated by arrows 14, flows from the interior of the room through the air filter 10 and is delivered into the air flow passage 12 on the opposite, downstream side 13 of the filter 10. With time the air permeable material forming the air filter becomes clogged with dust and other dirt particles sucked in from the upstream side 11. As a result, the amount of air delivered to the downstream side 13 is substantially reduced. To facilitate detection of the degree of contamination of the air filter 10, the present invention provides for a system of warnings incorporated into the HVAC system.

The warning device of the present invention comprises a sensor 20, which can be for instance a fan 20 having rotating blades 24. The sensor 20 is operationally connected to an electric current generator 22, which can be a low voltage motor means. The low voltage motor 22 generates electricity as the blades 24 of the fan 20 rotate in response to the air flow passing through the passage 12 into the air duct 18.

The sensor 20 and the generator 22 are conveniently mounted on a bracket 26 which is secured to the wall of the air duct 18 in the direct path of the air flow. The generator 22 is electrically connected to a control panel by a plurality of electrical wires. Some of the wires, shown in phantom lines designated by numeral 32, are connected to one or more of visual warning means, such as for instance light emitting members 34. The light emitting members 34 may be light emitting diodes (LEDs) mounted on the control panel 30.

Another electrical wire 36 lead to an audible warning indicator 38 mounted on the control panel 30. The control panel 30 may be mounted in close proximity to a thermostat (not shown) to allow visual and audible indication of the amount of airflow passing across the filter 10.

The LED lights 34 are preferably provided with different color lenses to allow a more precise determination of the degree of clogging of the filter 10. For instance, one of the lights 34 may have a green color lens, which would be indicative of an acceptable level of airflow across the filter 10. The green colored LED is designed to be illuminated when the fan 20 operates at its full capacity and generates the largest amount of electricity, for instance 1 millivolt.

Another LED light 34 may have a yellow lens; this LED is designed to be illuminated when the generator 22 generates less electricity than is sufficient to illuminate the green LED. Another LED light 34 may have an orange lens which will connect to the generator 22 when the electrical current is insufficient for illuminating the green or yellow lights. Finally, a red light 35 will be illuminated when the fan 20 does not rotate due to clogging of the filter and when the motor means 22 fails to generate sufficient electricity to power even the green, yellow or orange light. A backup battery (not shown) is incorporated in the control panel 30 to supply electricity to the light 35 giving a visual indication that the air filter 10 needs urgent replacement.

The audible warning device 38, which can be a buzzer or a whistle is likewise connected to the backup battery and sounds an audible signal whenever the supplied electricity is insufficient to illuminate the green, yellow, or orange light emitting devices. It is envisioned that the warning light 35 and the audible warning device 38 will operate contemporaneously giving both visual and audible signals to the homeowner or a technician that no power is coming from the generator 22 and the filter 10 needs to be replaced as soon as possible.

A relay switch 40 is mounted between the generator 22 and the control panel 30 to properly control the operation of the warning devices mounted on the control panel 30 and to correctly direct the electrical current to the designated light emitting member 34, 35 or to the audible warning member 38. A limit switch 42 is incorporated in the control panel 30 to allow switching between summer and winter modes of operation when the amount of air flow depends on whether a heating or a cooling system operates in a given time. The limit switch 42 allows the user to switch the system to recognize cooling or heating modes of the HVAC and thereby adjust the limits at which the warning system operates.

The present invention can also help determine whether the AC motor malfunctions by showing that no airflow is passing through the filter 10. To prevent total damage to the AC motor, the warning devices mounted on the control panel 30 would give an advanced warning of some malfunction in the HVAC system.

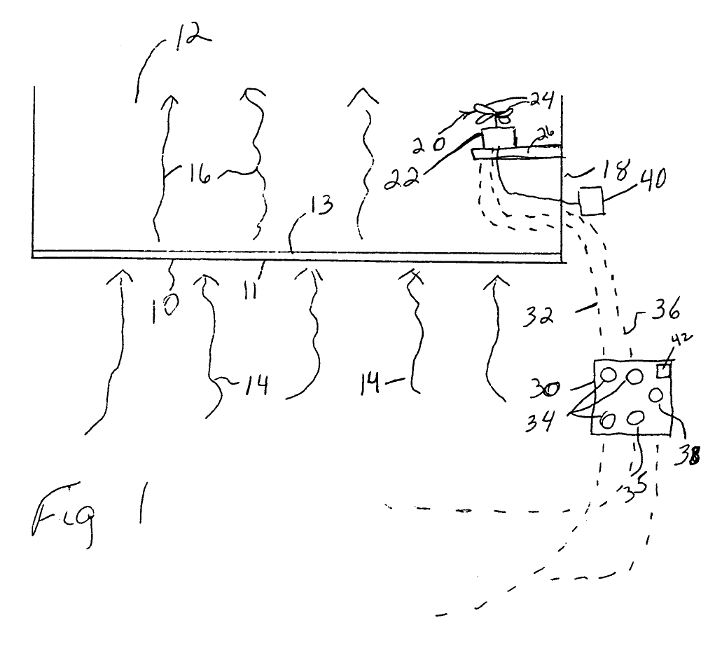

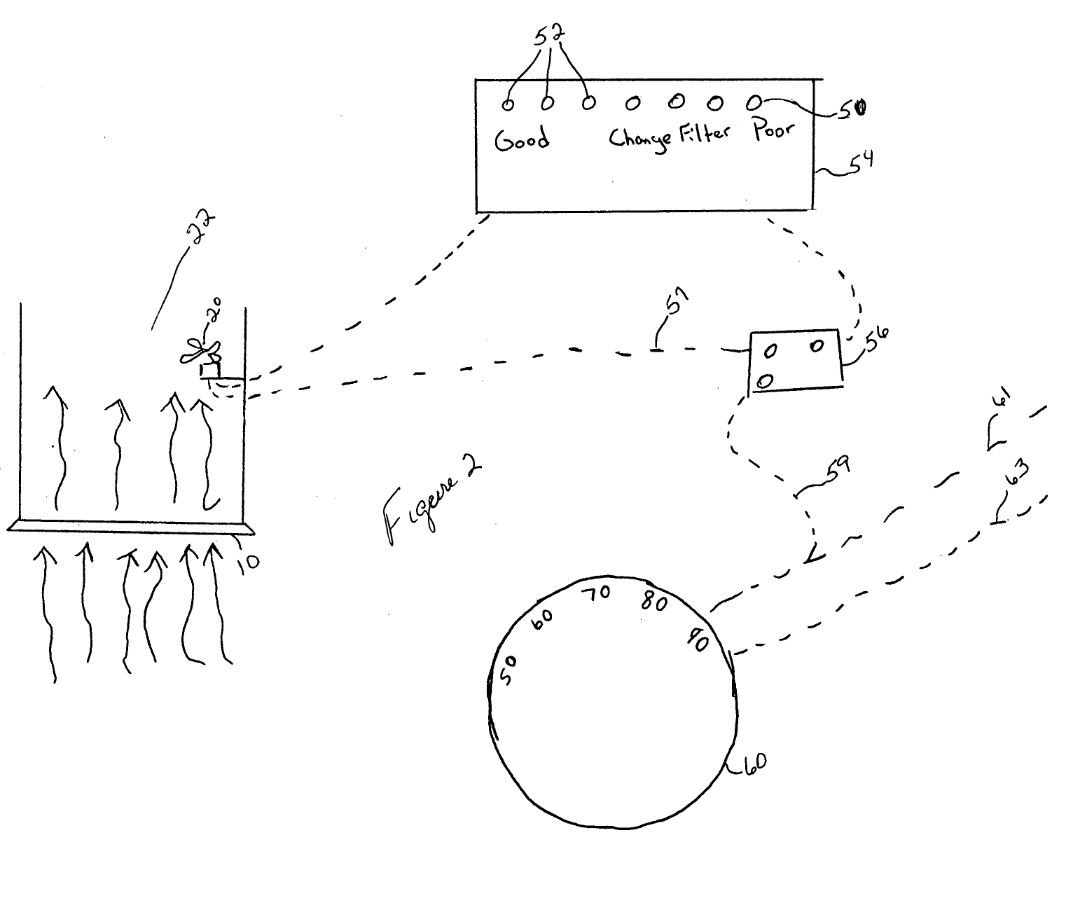

FIG. 2 illustrates an alternative schematic of a clogged filter warning system. As can be seen in the drawing, the sensor 20 and the electrical current generator 22 are similar to the first embodiment. The control panel is somewhat different. In the control panel 50, a series of light emitting members 52 is spaced in a sequential row, with an indicia under the light members “good,” “change filter,” and “poor.” The light members 52 have different color lenses, changing in hue from green to yellow, from yellow to red, where the light member 54 has a red color lens.

The limit switch 56 may be formed as a separate device, electrically connected to the control panel 50 and to the sensor 20 through the generator 22 and suitable wiring 57. Alternatively, the switch 56 may be mounted on the control panel 50. The on/off limit switch 56 is also connected to by suitable wiring 59 to a wall thermostat 60. Conventionally, the thermostat 60 is connected by wiring 61 to the HVAC unit (not shown) and to a transformer (not shown)—through suitable wiring 63.

Many changes and modifications can be made in the system of the present invention without departing from the spirit thereof. I therefore pray that my rights to the present invention be limited only by the scope of the appended claims.

1. A warning system for monitoring an air filter condition in an HVAC system having an air passage on a suction side of the air filter, the warning system comprising:
an air flow activated fan mounted in the air passage on the suction side of the air filter;
a motor means operationally connected to the fan, said motor means generating an electrical current in response to movement of the fan; and
a warning means adapted for mounting on an upstream side of the air filter and operationally connected to the motor means for providing a warning signal when the amount of an air flow passing across the air filter falls below a pre-determined value.

2. The warning system of claim 1, further comprising a means for supporting the fan and the motor means in the air passage.

3. The warning system of claim 2, wherein said supporting means comprises a bracket secured in the air passage, wherein said motor means is mounted on said bracket.

4. The warning system of claim 1, wherein said warning means comprises a control panel comprising at least one light emitting member.

5. The warning system of claim 1, where in said warning means comprises a control panel comprising a plurality of light emitting members and at least one sound emitting member.

6. The warning system of claim 5, wherein said light emitting members have different electric potential values to facilitate differentiating the amount of air flow passing across the air filter in response to a value of electrical current generated by the motor means.

7. The warning system of claim 6, further comprising an electrical relay for directing electrical current to a pre-determined light emitting member depending on the electrical potential of the light emitting member.

8. The warning system of claim 5, wherein said light emitting members comprise LED devices having different color lenses to facilitate differentiating the amount of air flow passing across the air filter.

9. The warning system of claim 1, further comprising a means for setting the threshold of the pre-determined air flow moving across the air filter.

10. A warning system for generating a warning signal upon the decrease of an air flow across an air filter having an upstream side and a downstream side, said means comprising:
a sensor mounted on the downstream side of the air filter;
a means for securing said sensor on the downstream side of the air filter;
a means for generating electrical current operationally connected to the sensor;
a warning means mounted on the upstream side of the air filter for displaying a warning signal in response to the decrease in the flow of air across the air filter.

11. The system of claim 10, wherein said sensor comprises a rotating fan having blades movable in response to the air flow passing on the downstream side of the air filter.

12. The system of claim 10, wherein said means for generating electrical current comprises an electrical power generator.

13. The system of claim 10, wherein said warning signal display means comprises at least one light emitting member operationally connected to said electrical current generating means.

14. The system of claim 10, wherein said warning signal display means comprises a plurality of light emitting members, said light emitting members having different electrical potential to facilitate differentiating the amount of an air flow reaching the downstream side of the air filter.

15. The system of claim 14, further comprising an electrical relay for directing electrical current to a pre-determined light emitting member depending on the electrical potential of the light emitting members.

16. The system of claim 10 wherein said warning display means comprises at least one audio signal emitting member.

17. The system of claim 10, further comprising a means for setting the threshold of the pre-determined air flow moving across the air filter.
